(19) United States
(12) Patent Application Publication
(10) Pub. No.: US 2026/0281960 A1
(43) Pub. Date: Sep. 17, 2026

(54) METHOD AND APPARATUS FOR REPORTING LOCATION INFORMATION BY USING SIDELINK COMMUNICATION

(71) Applicant: IUCF-HYU (INDUSTRY-UNIVERSITY COOPERATION FOUNDATION HANYANG UNIVERSITY), Seoul (KR)

(72) Inventors: Sunwoo Kim, Seoul (KR); Hongseok JUNG, Seoul (KR); Nakyung LEE, Seoul (KR); Suah PARK, Seoul (KR)

(21) Appl. No.: 19/672,208

(22) Filed: May 8, 2026

Related U.S. Application Data
(63) Continuation of application No. PCT/KR2024/017680, filed on Nov. 8, 2024.

(30) Foreign Application Priority Data
Nov. 8, 2023 (KR) 10-2023-0153526
Nov. 6, 2024 (KR) 10-2024-0156393

(51) Int. Cl. H04W 64/00; H04W 24/10

(52) U.S. Cl. CPC H04W 64/00; H04W 24/10

(57) ABSTRACT

The present disclosure relates to a technology for reporting location information by using a sidelink communication technology, and provides a method and an apparatus for reporting, by a terminal, location information by using sidelink communication, the method comprising the steps of: receiving a sidelink-positioning reference signal (SL-PRS) from a plurality of other terminals through sidelink communication; configuring a measurement report on the basis of reception information of the SL-PRS; and transmitting the measurement report to a core network entity.

### CROSS-REFERENCE TO RELATED APPLICATION

This application is a bypass continuation of pending PCT International Application No. PCT/KR2024/017680, which was filed on Nov. 8, 2024, and which claims priority to and the benefit of Korean Patent Application No. 10-2024-0156393 filed with the Korean Intellectual Property Office on Nov. 6, 2024, and Korean Patent Application No. 10-2023-0153526 filed with the Korean Intellectual Property Office on Nov. 8, 2023, the disclosures of which are incorporated herein by reference in their entirety.

### TECHNICAL FIELD

The present disclosure relates to a technology for reporting location information using sidelink communication technology.

### BACKGROUND ART

Sidelink communication refers to a technology for performing direct communication between user equipments without passing through a base station. Sidelink communication may be referred to by various terms such as V2X or D2D.

For example, sidelink communication may be applied to vehicle-to-vehicle communication. In the case of vehicle-to-vehicle communication, vehicles transmit and receive data between vehicles using a physical resource allocated from a base station or a specific physical resource selected by a user equipment from a physical resource pool.

In addition, since it is a technology that minimizes intervention of a base station, obtaining information on an accurate location of a user equipment (vehicle) may be important. For example, in the case of a vehicle, the length is set to 5 m and the width is set to 2 m, and even when a certain level of error occurs in consideration of a lane width or the like while driving on a road, a risk such as a collision may occur.

Therefore, a technology for accurate location measurement of a user equipment (vehicle) in a sidelink communication environment is required. In the case of base station-based location measurement, there may be a limit to accurate location measurement for a vehicle moving at high speed. In addition, when the vehicle is located outside base station coverage, accurate location measurement may be difficult.

In this aspect, a location measurement technology using sidelink communication is required.

### DETAILED DESCRIPTION OF THE INVENTION

### Technical Problem

The present embodiments are intended to provide a technology for obtaining location information with high accuracy in sidelink communication.

### Technical Solution

In one aspect, the present embodiments provide a method of reporting location information using sidelink communication by a user equipment, the method comprising: receiving a Sidelink-Positioning Reference Signal (SL-PRS) from a plurality of other user equipments through the sidelink communication; configuring a measurement report based on reception information of the SL-PRS; and transmitting the measurement report to a core network entity.

In another aspect, the present embodiments provide a user equipment device reporting location information using sidelink communication, the user equipment device comprising: a receiver configured to receive a Sidelink-Positioning Reference Signal (SL-PRS) from a plurality of other user equipments through the sidelink communication; a controller configured to configure a measurement report based on reception information of the SL-PRS; and a transmitter configured to transmit the measurement report to a core network entity.

### Advantageous Effects

The present embodiments can provide a technology for obtaining location information with high accuracy in sidelink communication.

### BRIEF DESCRIPTION OF THE DRAWINGS

FIG. 1 is a diagram briefly illustrating a structure of an NR wireless communication system to which the present embodiment may be applied.

FIG. 2 is a diagram for explaining a frame structure in an NR system to which the present embodiment may be applied.

FIG. 3 is a diagram for explaining a resource grid supported by a wireless access technology to which the present embodiment may be applied.

FIG. 4 is a diagram for explaining a bandwidth part supported by a wireless access technology to which the present embodiment may be applied.

FIG. 5 is a diagram exemplarily illustrating a synchronization signal block in a wireless access technology to which the present embodiment may be applied.

FIG. 6 is a diagram for explaining a random access procedure in a wireless access technology to which the present embodiment may be applied.

FIG. 7 is a diagram for explaining a CORESET.

FIG. 8 is a diagram for explaining a base station-based user equipment location estimation operation.

FIG. 9 is a diagram for explaining a user equipment operation according to an embodiment.

FIG. 10 is a diagram for explaining a user equipment operation according to another embodiment.

FIG. 11 is a diagram for explaining a signal flow between a core network entity and a user equipment according to an embodiment.

FIG. 12 is a diagram for explaining a signal flow from a user equipment to a core network entity according to another embodiment.

FIG. 13 is a diagram for explaining a groupcast-based location reporting operation according to an embodiment.

FIG. 14 is a diagram for explaining a unicast-based location reporting operation according to another embodiment.

FIG. 15 is a flowchart for explaining an operation of delivering transmission time information according to an embodiment.

FIG. 16 is a diagram illustrating a user equipment configuration according to an embodiment.

### MODE FOR CARRYING OUT THE INVENTION

Hereinafter, some embodiments of the present disclosure will be described in detail with reference to the accompanying illustrative drawings. In the drawings, like reference numerals are used to denote like elements throughout the drawings, even if they are shown on different drawings. Further, in the following description of the present disclosure, a detailed description of known functions and configurations incorporated herein will be omitted when it may make the subject matter of the present disclosure rather unclear. When the expression “include”, “have”, “comprise”, or the like as mentioned herein is used, any other part may be added unless the expression “only” is used. When an element is expressed in the singular, the element may cover the plural form unless a special mention is explicitly made of the element.

In addition, terms, such as first, second, A, B, (A), (B) or the like may be used herein when describing components of the present disclosure. Each of these terminologies is not used to define an essence, order or sequence of a corresponding component but used merely to distinguish the corresponding component from other component(s).

In describing the positional relationship between components, if two or more components are described as being “connected”, “combined”, or “coupled” to each other, it should be understood that two or more components may be directly “connected”, “combined”, or “coupled” to each other, and that two or more components may be “connected”, “combined”, or “coupled” to each other with another component “interposed” therebetween. In this case, another component may be included in at least one of the two or more components that are “connected”, “combined”, or “coupled” to each other.

In the description of a sequence of operating methods or manufacturing methods, for example, the expressions using “after”, “subsequent to”, “next”, “before”, and the like may also encompass the case in which operations or processes are performed discontinuously unless “immediately” or “directly” is used in the expression.

Numerical values for components or information corresponding thereto (e.g., levels or the like), which are mentioned herein, may be interpreted as including an error range caused by various factors (e.g., process factors, internal or external impacts, noise, etc.) even if an explicit description thereof is not provided.

The wireless communication system in the present specification refers to a system for providing various communication services, such as a voice service and a data service, using radio resources. The wireless communication system may include a user equipment (UE), a base station, a core network, and the like.

Embodiments disclosed below may be applied to a wireless communication system using various radio access technologies. For example, the embodiments may be applied to various radio access technologies such as code division multiple access (CDMA), frequency division multiple access (FDMA), time division multiple access (TDMA), orthogonal frequency division multiple access (OFDMA), single-carrier frequency division multiple access (SC-FDMA), non-orthogonal multiple access (NOMA), or the like. In addition, the radio access technology may refer to respective generation communication technologies established by various communication organizations, such as 3GPP, 3GPP2, WiFi, Bluetooth, IEEE, ITU, or the like, as well as a specific access technology. For example, CDMA may be implemented as a wireless technology such as universal terrestrial radio access (UTRA) or CDMA2000. TDMA may be implemented as a wireless technology such as global system for mobile communications (GSM)/general packet radio service (GPRS)/enhanced data rates for GSM evolution (EDGE). OFDMA may be implemented as a wireless technology such as IEEE (Institute of Electrical and Electronics Engineers) 802.11 (Wi-Fi), IEEE 802.16 (WiMAX), IEEE 802-20, evolved UTRA (E-UTRA), and the like. IEEE 802.16m is evolution of IEEE 802.16e, which provides backward compatibility with systems based on IEEE 802.16e. UTRA is a part of a universal mobile telecommunications system (UMTS). 3GPP (3rd-generation partnership project) LTE (long-term evolution) is a part of E-UMTS (evolved UMTS) using evolved-UMTS terrestrial radio access (E-UTRA), which adopts OFDMA in a downlink and SC-FDMA in an uplink. As described above, the embodiments may be applied to radio access technologies that have been launched or commercialized, and may be applied to radio access technologies that are being developed or will be developed in the future.

The UE used in the specification must be interpreted as a broad meaning that indicates a device including a wireless communication module that communicates with a base station in a wireless communication system. For example, the UE includes user equipment (UE) in WCDMA, LTE, NR, HSPA, IMT-2020 (5G or New Radio), and the like, a mobile station in GSM, a user terminal (UT), a subscriber station (SS), a wireless device, and the like. In addition, the UE may be a portable user device, such as a smart phone, or may be a vehicle, a device including a wireless communication module in the vehicle, and the like in a V2X communication system according to the usage type thereof. In the case of a machine-type communication (MTC) system, the UE may refer to an MTC terminal, an M2M terminal, or a URLLC terminal, which employs a communication module capable of performing machine-type communication.

A base station or a cell in the present specification refers to an end that communicates with a UE through a network and encompasses various coverage regions such as a Node-B, an evolved Node-B (eNB), a gNode-B, a low-power node (LPN), a sector, a site, various types of antennas, a base transceiver system (BTS), an access point, a point (e.g., a transmission point, a reception point, or a transmission/reception point), a relay node, a megacell, a macrocell, a microcell, a picocell, a femtocell, a remote radio head (RRH), a radio unit (RU), a small cell, and the like. In addition, the cell may be used as a meaning including a bandwidth part (BWP) in the frequency domain. For example, the serving cell may refer to an active BWP of a UE.

The various cells listed above are provided with a base station controlling one or more cells, and the base station may be interpreted as two meanings. The base station may be 1) a device for providing a megacell, a macrocell, a microcell, a picocell, a femtocell, or a small cell in connection with a wireless region, or the base station may be 2) a wireless region itself. In the above description 1), the base station may be the devices controlled by the same entity and providing predetermined wireless regions or all devices interacting with each other and cooperatively configuring a wireless region. For example, the base station may be a point, a transmission/reception point, a transmission point, a reception point, and the like according to the configuration method of the wireless region. In the above description 2), the base station may be the wireless region in which a user equipment (UE) may be enabled to transmit data to and receive data from the other UE or a neighboring base station.

In this specification, the cell may refer to coverage of a signal transmitted from a transmission/reception point, a component carrier having coverage of a signal transmitted from a transmission/reception point (or a transmission point), or a transmission/reception point itself.

An uplink (UL) refers to a scheme of transmitting data from a UE to a base station, and a downlink (DL) refers to a scheme of transmitting data from a base station to a UE. The downlink may mean communication or communication paths from multiple transmission/reception points to a UE, and the uplink may mean communication or communication paths from a UE to multiple transmission/reception points. In the downlink, a transmitter may be a part of the multiple transmission/reception points, and a receiver may be a part of the UE. In addition, in the uplink, the transmitter may be a part of the UE, and the receiver may be a part of the multiple transmission/reception points.

The uplink and downlink transmit and receive control information over a control channel, such as a physical downlink control channel (PDCCH) and a physical uplink control channel (PUCCH). The uplink and downlink transmit and receive data over a data channel such as a physical downlink shared channel (PDSCH) and a physical uplink shared channel (PUSCH). Hereinafter, the transmission and reception of a signal over a channel, such as PUCCH, PUSCH, PDCCH, PDSCH, or the like, may be expressed as “PUCCH, PUSCH, PDCCH, PDSCH, or the like is transmitted and received”.

For the sake of clarity, the following description will focus on 3GPP LTE/LTE-A/NR (New Radio) communication systems, but technical features of the disclosure are not limited to the corresponding communication systems.

The 3GPP has been developing a 5G (5th-Generation) communication technology in order to meet the requirements of a next-generation radio access technology of ITU-R after studying 4G (4th-generation) communication technology. Specifically, 3GPP is developing, as a 5G communication technology, LTE-A pro by improving the LTE-Advanced technology so as to conform to the requirements of ITU-R and a new NR communication technology that is totally different from 4G communication technology. LTE-A pro and NR all refer to the 5G communication technology. Hereinafter, the 5G communication technology will be described on the basis of NR unless a specific communication technology is specified.

Various operating scenarios have been defined in NR in consideration of satellites, automobiles, new verticals, and the like in the typical 4G LTE scenarios so as to support an enhanced mobile broadband (eMBB) scenario in terms of services, a massive machine-type communication (mMTC) scenario in which UEs spread over a broad region at a high UE density, thereby requiring low data rates and asynchronous connections, and an ultra-reliability and low-latency (URLLC) scenario that requires high responsiveness and reliability and supports high-speed mobility.

In order to satisfy such scenarios, NR introduces a wireless communication system employing a new waveform and frame structure technology, a low-latency technology, a super-high frequency band (mmWave) support technology, and a forward compatible provision technology. In particular, the NR system has various technological changes in terms of flexibility in order to provide forward compatibility. The primary technical features of NR will be described below with reference to the drawings.

### <Overview of NR System>

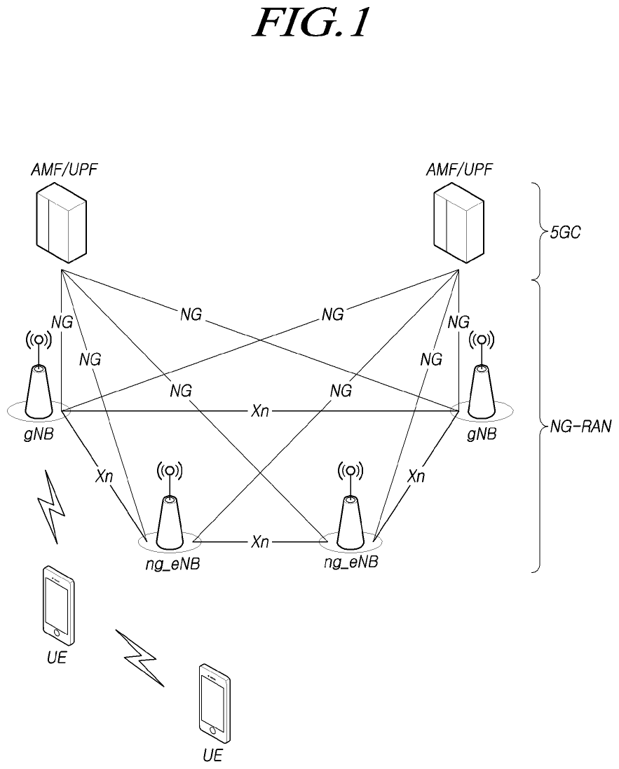

FIG. 1 is a view schematically illustrating an NR system to which the present embodiment is applicable.

Referring to FIG. 1, the NR system is divided into a 5G core network (5GC) and an NG-RAN part. The NG-RAN comprises gNBs and ng-eNBs providing user plane (SDAP/PDCP/RLC/MAC/PHY) and user equipment (UE) control plane (RRC) protocol ends. The gNBs or the gNB and the ng-eNB are connected to each other through Xn interfaces. The gNB and the ng-eNB are connected to the 5GC through NG interfaces, respectively. The 5GC may be configured to include an access and mobility management function (AMF) for managing a control plane, such as a UE connection and mobility control function, and a user plane function (UPF) controlling user data. NR supports both frequency bands below 6 GHz (frequency range 1 (FR1)) and frequency bands equal to or greater than 6 GHz (frequency range 2 (FR2)).

The gNB denotes a base station that provides a UE with an NR user plane and control plane protocol end. The ng-eNB denotes a base station that provides a UE with an E-UTRA user plane and control plane protocol end. The base station described in the present specification should be understood as encompassing the gNB and the ng-eNB. However, the base station may be also used to refer to the gNB or the ng-eNB separately from each other, as necessary.

### <NR Waveform, Numerology, and Frame Structure>

NR uses a CP-OFDM waveform using a cyclic prefix for downlink transmission and uses CP-OFDM or DFT-s-OFDM for uplink transmission. OFDM technology is easy to combine with a multiple-input multiple-output (MIMO) scheme and allows a low-complexity receiver to be used with high frequency efficiency.

Since the three scenarios described above have different requirements for data rates, delay rates, coverage, and the like from each other in NR, it is necessary to efficiently satisfy the requirements for each scenario over frequency bands constituting the NR system. To this end, a technique for efficiently multiplexing radio resources based on a plurality of different numerologies has been proposed.

Specifically, the NR transmission numerology is determined on the basis of subcarrier spacing and a cyclic prefix (CP). As shown in Table 1 below, “u” is used as an exponential value of 2 so as to be changed exponentially on the basis of 15 kHz.

TABLE 1

| | Subcarrier | | Supported for | Supported for |
|---|---|---|---|---|
| μ | spacing | Cyclic prefix | data | synch |
| 0 | 15 | normal | Yes | Yes |
| 1 | 30 | normal | Yes | Yes |
| 2 | 60 | Normal, | Yes | No |
| | | Extended | | |
| 3 | 120 | normal | Yes | Yes |
| 4 | 240 | normal | No | Yes |

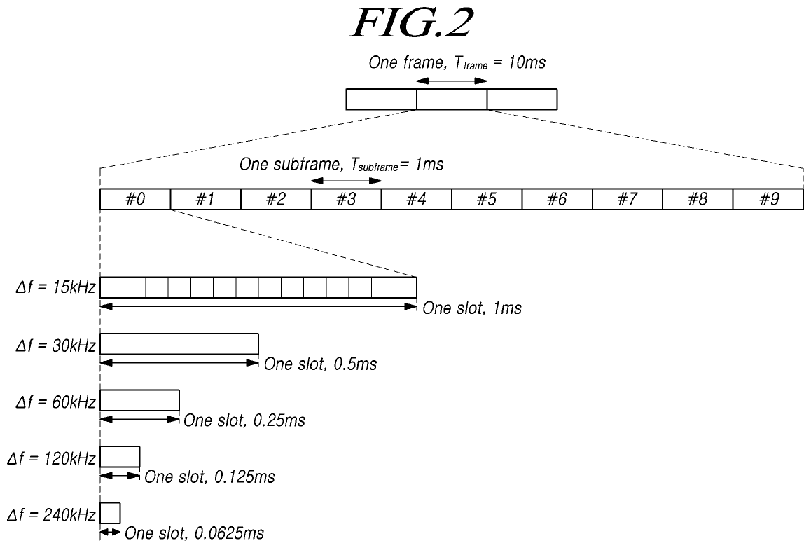

As shown in Table 1 above, NR may have five types of numerologies according to subcarrier spacing. This is different from LTE, which is one of the 4G-communication technologies, in which the subcarrier spacing is fixed to 15 kHz. Specifically, in NR, subcarrier spacing used for data transmission is 15, 30, 60, or 120 kHz, and subcarrier spacing used for synchronization signal transmission is 15, 30, 120, or 240 kHz. In addition, an extended CP is applied only to the subcarrier spacing of 60 kHz. A frame that includes 10 subframes each having the same length of 1 ms and has a length of 10 ms is defined in the frame structure in NR. One frame may be divided into half frames of 5 ms, and each half frame includes 5 subframes. In the case of a subcarrier spacing of 15 kHz, one subframe includes one slot, and each slot includes 14 OFDM symbols. FIG. 2 is a view for explaining a frame structure in an NR system to which the present embodiment may be applied. Referring to FIG. 2, a slot includes 14 OFDM symbols, which are fixed, in the case of a normal CP, but the length of the slot in the time domain may be varied depending on subcarrier spacing. For example, in the case of a numerology having a subcarrier spacing of 15 kHz, the slot is configured to have the same length of 1 ms as that of the subframe. On the other hand, in the case of a numerology having a subcarrier spacing of 30 kHz, the slot includes 14 OFDM symbols, but one subframe may include two slots each having a length of 0.5 ms. That is, the subframe and the frame may be defined using a fixed time length, and the slot may be defined as the number of symbols such that the time length thereof is varied depending on the subcarrier spacing.

NR defines a basic unit of scheduling as a slot and also introduces a minislot (or a subslot or a non-slot-based schedule) in order to reduce a transmission delay of a radio section. If wide subcarrier spacing is used, the length of one slot is shortened in inverse proportion thereto, thereby reducing a transmission delay in the radio section. A minislot (or subslot) is intended to efficiently support URLLC scenarios, and the minislot may be scheduled in 2, 4, or 7 symbol units.

In addition, unlike LTE, NR defines uplink and downlink resource allocation as a symbol level in one slot. In order to reduce a HARQ delay, the slot structure capable of directly transmitting HARQ ACK/NACK in a transmission slot has been defined. Such a slot structure is referred to as a self-contained structure, which will be described.

NR was designed to support a total of 256 slot formats, and 62 slot formats thereof are used in 3GPP Rel-15. In addition, NR supports a common frame structure constituting an FDD or TDD frame through combinations of various slots. For example, NR supports i) a slot structure in which all symbols of a slot are configured for a downlink, ii) a slot structure in which all symbols are configured for an uplink, and iii) a slot structure in which downlink symbols and uplink symbols are mixed. In addition, NR supports data transmission that is scheduled to be distributed to one or more slots. Accordingly, the base station may inform the UE of whether the slot is a downlink slot, an uplink slot, or a flexible slot using a slot format indicator (SFI). The base station may inform a slot format by instructing, using the SFI, the index of a table configured through UE-specific RRC signaling. Further, the base station may dynamically instruct the slot format through downlink control information (DCI) or may statically or quasi-statically instruct the same through RRC signaling.

### <Physical Resources of NR>

With regard to physical resources in NR, antenna ports, resource grids, resource elements, resource blocks, bandwidth parts, and the like are taken into consideration.

The antenna port is defined to infer a channel carrying a symbol on an antenna port from the other channel carrying another symbol on the same antenna port. If large-scale properties of a channel carrying a symbol on an antenna port can be inferred from the other channel carrying a symbol on another antenna port, the two antenna ports may have a quasi-co-located or quasi-co-location (QC/QCL) relationship. The large-scale properties include at least one of delay spread, Doppler spread, a frequency shift, an average received power, and a received timing.

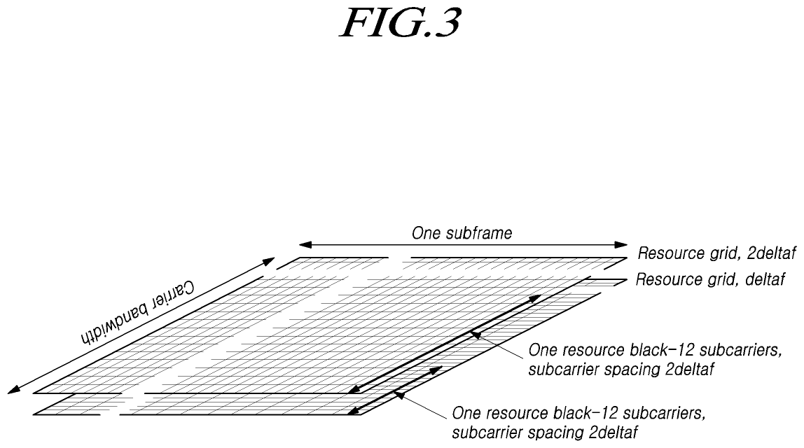

FIG. 3 illustrates resource grids supported by a radio access technology in accordance with embodiments of the present disclosure.

Referring to FIG. 3, resource grids may exist according to respective numerologies because NR supports a plurality of numerologies in the same carrier. In addition, the resource grids may exist depending on antenna ports, subcarrier spacing, and transmission directions.

A resource block includes 12 subcarriers and is defined only in the frequency domain. In addition, a resource element includes one OFDM symbol and one subcarrier. Therefore, as shown in FIG. 3, the size of one resource block may be varied according to the subcarrier spacing. Further, “Point A” that acts as a common reference point for the resource block grids, a common resource block, and a virtual resource block are defined in NR.

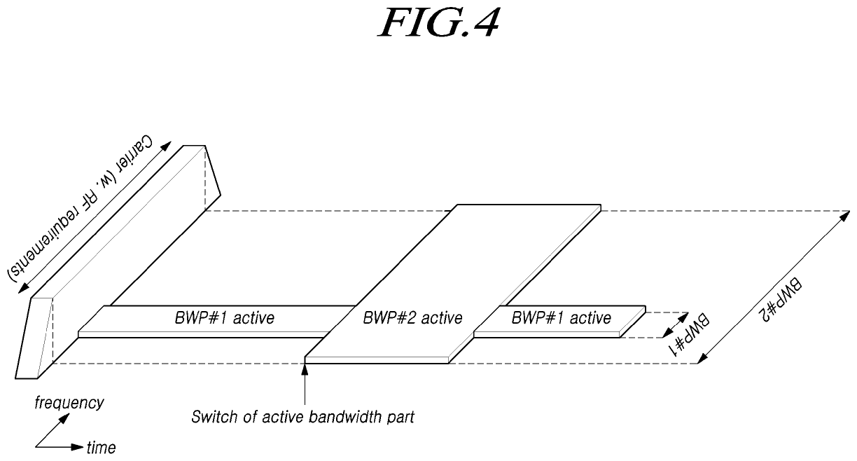

FIG. 4 illustrates bandwidth parts supported by a radio access technology in accordance with embodiments of the present disclosure.

Unlike LTE in which the carrier bandwidth is fixed to 20 MHz, the maximum carrier bandwidth is configured as 50 MHz to 400 MHz depending on the subcarrier spacing in NR. Therefore, it is not assumed that all UEs use the entire carrier bandwidth. Accordingly, as shown in FIG. 4, bandwidth parts (BWPs) may be specified within the carrier bandwidth in NR so that the UE may use the same. In addition, the bandwidth part may be associated with one numerology, may include a subset of consecutive common resource blocks, and may be activated dynamically over time. The UE has up to four bandwidth parts in each of the uplink and the downlink. The UE transmits and receives data using an activated bandwidth part during a given time.

In the case of a paired spectrum, uplink and downlink bandwidth parts are configured independently. In the case of an unpaired spectrum, in order to prevent unnecessary frequency re-tuning between a downlink operation and an uplink operation, the downlink bandwidth part and the uplink bandwidth part are configured in pairs to share a center frequency.

### <Initial Access in NR>

In NR, a UE performs a cell search and a random access procedure in order to access and communicate with a base station.

The cell search is a procedure of the UE for synchronizing with a cell of a corresponding base station using a synchronization signal block (SSB) transmitted from the base station and acquiring a physical-layer cell ID and system information.

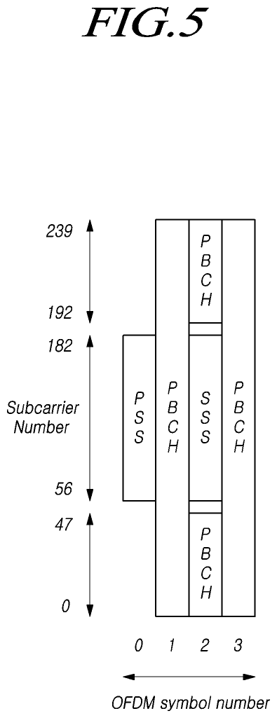

FIG. 5 illustrates an example of a synchronization signal block in a radio access technology in accordance with embodiments of the present disclosure.

Referring to FIG. 5, the SSB comprises a primary synchronization signal (PSS) and a secondary synchronization signal (SSS), which occupy one symbol and 127 subcarriers, and PBCHs spanning three OFDM symbols and 240 subcarriers.

The UE monitors the SSB in the time and frequency domain, thereby receiving the SSB.

The SSB may be transmitted up to 64 times for 5 ms. A plurality of SSBs are transmitted by different transmission beams within a time of 5 ms, and the UE performs detection on the assumption that the SSB is transmitted every 20 ms based on a specific beam used for transmission. The number of beams that may be used for SSB transmission within 5 ms may be increased as the frequency band is increased. For example, up to 4 SSB beams may be transmitted at a frequency band of 3 GHz or less, and up to 8 SSB beams may be transmitted at a frequency band of 3 to 6 GHz. In addition, the SSBs may be transmitted using up to 64 different beams at a frequency band of 6 GHz or more.

One slot comprises two SSBs, and a start symbol and the number of repetitions in the slot are determined according to subcarrier spacing as follows.

Unlike the SS in the typical LTE system, the SSB is not transmitted at the center frequency of a carrier bandwidth. That is, the SSB may also be transmitted at a frequency other than the center of the system band, and a plurality of SSBs may be transmitted in the frequency domain in the case of supporting a broadband operation. Accordingly, the UE monitors the SSB using a synchronization raster, which is a candidate frequency position for monitoring the SSB. A carrier raster and a synchronization raster, which are center frequency position information of a channel for initial connection, were newly defined in NR, and the synchronization raster may support a fast SSB search of the UE because the frequency spacing thereof is configured to be wider than that of the carrier raster.

The UE may acquire an MIB over the PBCH of the SSB. The MIB (master information block) comprises minimum information for the UE to receive remaining minimum system information (RMSI) broadcast by the network. In addition, the PBCH may comprise information on the position of the first DM-RS symbol in the time domain, information for the UE to monitor SIB1 (e.g., SIB1 numerology information, information related to SIB1 CORESET, search space information, PDCCH-related parameter information, etc.), offset information between the common resource block and the SSB (the position of an absolute SSB in the carrier is transmitted via SIB1), and the like. The SIB1 numerology information is also applied to some messages used in the random access procedure for the UE to access the base station after completing the cell search procedure. For example, the numerology information of SIB1 may be applied to at least one of the messages 1 to 4 for the random access procedure.

The above-mentioned RMSI may mean SIB1 (system information block 1), and SIB1 is broadcast periodically (e.g., 160 ms) in the cell. SIB1 comprises information necessary for the UE to perform the initial random access procedure, and SIB1 is periodically transmitted over a PDSCH. In order to receive SIB1, the UE must receive numerology information used for the SIB1 transmission and CORESET (control resource set) information used for scheduling of SIB1 over a PBCH. The UE identifies scheduling information for SIB1 using SI-RNTI in the CORESET. The UE acquires SIB1 on the PDSCH according to scheduling information. The remaining SIBs other than SIB1 may be periodically transmitted, or the remaining SIBs may be transmitted according to the request of the UE.

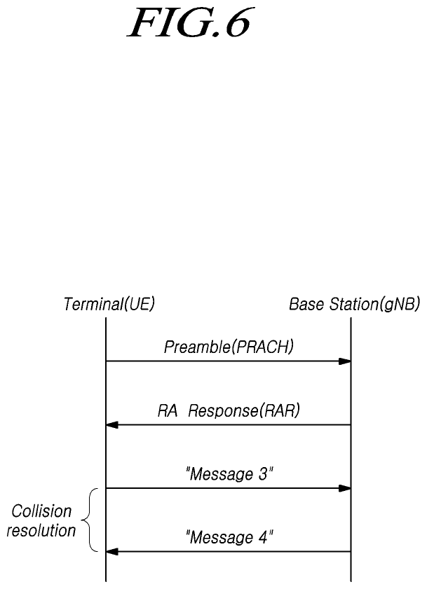

FIG. 6 is a view for explaining a random access procedure in a radio access technology to which the present embodiment is applicable.

Referring to FIG. 6, when a cell search is completed, the UE transmits a random access preamble for random access to the base station. The random access preamble is transmitted over a PRACH. Specifically, the random access preamble is periodically transmitted to the base station over the PRACH that comprises consecutive radio resources repeated in a specific slot. In general, a contention-based random access procedure is performed when the UE makes initial access to a cell, and a non-contention-based random access procedure is performed when the UE performs random access for beam failure recovery (BFR).

The UE receives a random access response to the transmitted random access preamble. The random access response may comprise a random access preamble identifier (ID), UL Grant (uplink radio resource), a temporary C-RNTI (temporary cell-radio network temporary identifier), and a TAC (time alignment command). Since one random access response may comprise random access response information for one or more UEs, the random access preamble identifier may be comprised in order to indicate the UE for which the comprised UL Grant, temporary C-RNTI, and TAC are valid. The random access preamble identifier may be an identifier of the random access preamble received by the base station. The TAC may be comprised as information for the UE to adjust uplink synchronization. The random access response may be indicated by a random access identifier on the PDCCH, i.e., a random access-radio network temporary identifier (RA-RNTI).

Upon receiving a valid random access response, the UE processes information comprised in the random access response and performs scheduled transmission to the base station. For example, the UE applies the TAC and stores the temporary C-RNTI. In addition, the UE transmits, to the base station, data stored in the buffer of the UE or newly generated data using the UL Grant. In this case, information for identifying the UE must be comprised in the data.

Lastly, the UE receives a downlink message to resolve the contention.

### <NR CORESET>

The downlink control channel in NR is transmitted in a CORESET (control resource set) comprising a length of 1 to 3 symbols, and the downlink control channel transmits uplink/downlink scheduling information, an SFI (slot format index), TPC (transmit power control) information, and the like.

As described above, NR has introduced the concept of CORESET to secure system flexibility. The CORESET (control resource set) refers to a time-frequency resource for a downlink control signal. The UE may decode a control channel candidate using one or more search spaces in the CORESET time-frequency resource. A CORESET-specific QCL (quasi-colocation) assumption is configured and is used for the purpose of providing information on characteristics of analog beam directions, as well as delay spread, Doppler spread, Doppler shift, and an average delay, which are characteristics assumed by existing QCL.

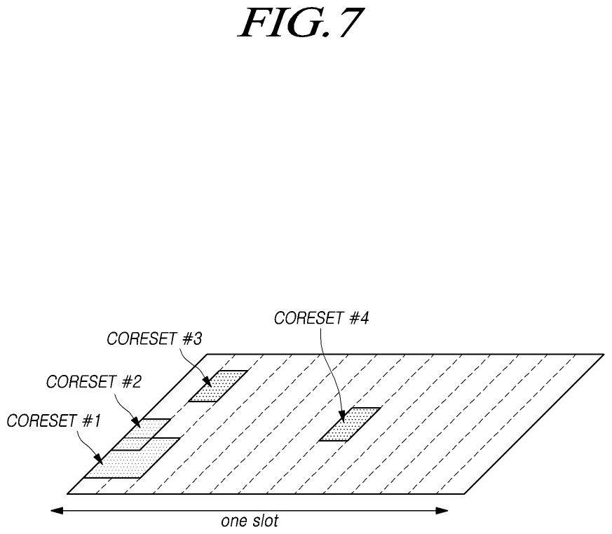

FIG. 7 illustrates a CORESET.

Referring to FIG. 7, CORESETs may exist in various forms within a carrier bandwidth in a single slot, and the CORESET may comprise a maximum of 3 OFDM symbols in the time domain. In addition, the CORESET is defined as a multiple of six resource blocks up to the carrier bandwidth in the frequency domain.

A first CORESET, as a portion of an initial bandwidth part, is designated (e.g., instructed, assigned) through an MIB to receive additional configuration information and system information from a network. After establishing a connection with the base station, the UE may receive and configure one or more pieces of CORESET information through RRC signaling.

In this specification, a frequency, a frame, a subframe, a resource, a resource block, a region, a band, a subband, a control channel, a data channel, a synchronization signal, various reference signals, various signals, or various messages in relation to NR (New Radio) may be interpreted as meanings used at present or in the past or as various meanings to be used in the future.

### <LTE Sidelink>

In an existing LTE system, radio channels and radio protocols for direct communication between user equipments (i.e., sidelink) have been designed for providing direct communication between user equipments and V2X (particularly V2V) services.

In relation to sidelink, PSSS/SSSS, which are synchronization signals for synchronization between a wireless sidelink transmitter and a receiver, and a PSBCH (Physical Sidelink Broadcasting Channel) for transmitting and receiving a related sidelink MIB (Master Information Block) have been defined. Furthermore, a design has been made for a PSDCH (Physical Sidelink Discovery Channel) for transmitting and receiving discovery information, a PSCCH (Physical Sidelink Control Channel) for transmitting and receiving SCI (Sidelink Control Information), and a PSSCH (Physical Sidelink Shared Channel) for transmitting and receiving sidelink data.

In addition, for wireless resource allocation for sidelink, technology has been developed, classified into mode 1 where a base station allocates wireless resources and mode 2 where a user equipment selects and allocates from a wireless resource pool. Furthermore, the LTE system required further technical evolution to satisfy V2X scenarios.

In this environment, 3GPP derived 27 service scenarios related to vehicle awareness in Rel-14 and determined key performance requirements according to road conditions. In addition, in recent Rel-15, 25 more advanced service scenarios, such as platooning, advanced driving, and remote vehicle sensors, were derived, and 6 performance requirements were determined.

To satisfy these performance requirements, technology development has been conducted to improve the performance of sidelink technology developed based on conventional D2D communication to meet V2X requirements. In particular, to apply to C-V2X (Cellular-V2X), technology for improving the physical layer design of sidelink to be suitable for high-speed environments, resource allocation technology, and synchronization technology may be selected as key research technologies.

The sidelink described below refers to a link used for D2D communication developed after 3GPP Rel-12 and V2X communication after Rel-14, and each channel term, synchronization term, resource term, and the like are described using the same terms regardless of D2D communication requirements and V2X Rel-14, 15 requirements. However, for convenience of understanding, differences in sidelink satisfying V2X scenario requirements are described, focusing on sidelink for D2D communication in Rel-12/13 as a reference, as needed. Therefore, terms related to sidelink described below are merely explained by dividing D2D communication/V2X communication/C-V2X communication for comparison differences and convenience of understanding, and are not limitedly applied to a specific scenario.

A V2X user equipment (denoted as a vehicle, but may be variously configured as a user equipment, etc.) may be located within a base station (eNB or gNB or ng-eNB) coverage or outside the base station coverage. For example, communication may be performed between user equipments within the base station coverage (UE N-1, UE G-1, UE X), or between a user equipment within the base station coverage and a user equipment outside the base station coverage (e.g., UE N-1, UE N-2). Alternatively, communication may be performed between user equipments outside the base station coverage (e.g., UE G-1, UE G-2).

In these various scenarios, for a corresponding user equipment to perform communication using sidelink, allocation of wireless resources for communication is required, and wireless resource allocation broadly comprises a base station handling allocation method and a method where a user equipment selects and allocates resources by itself.

Specifically, in D2D, resource allocation methods for user equipments comprise a centralized method (Mode 1) where a base station intervenes in resource selection and management, and a distributed method (Mode 2) where a user equipment randomly selects pre-configured resources. Similar to D2D, C-V2X also comprises a method (Mode 3) where a base station intervenes in resource selection and management, and a method (Mode 4) where a vehicle directly selects resources in V2X. In Mode 3, the base station schedules an SA (Scheduling Assignment) pool resource region and a DATA pool resource region allocated thereto for a transmitting user equipment.

### <NR Sidelink>

As described above, unlike V2X based on an LTE system, there is a demand for NR-based V2X technology to satisfy complex requirements such as autonomous driving.

In the case of NR V2X, by applying NR frame structures, numerologies, channel transmission/reception procedures, etc., it is intended to enable flexible V2X service provision in more diverse environments. To this end, resource sharing technology between a base station and a user equipment, sidelink Carrier Aggregation (CA) technology, partial sensing technology for pedestrian user equipments, and technology development such as sTTI are required.

In NR V2X, not only broadcast used in LTE V2X but also unicast and groupcast are supported. At this time, for groupcast and unicast, a target group ID is used, but whether to use a source ID is to be discussed later.

Further, as HARQ is supported for QoS, control information also comprises a HARQ Process ID. In LTE HARQ, a PUCCH for HARQ is transmitted after four subframes after downlink transmission, but in NR HARQ, PUCCH resources and feedback timing may be indicated by, for example, a PUCCH resource indicator or a PDSCH-to-HARQ feedback timing indicator for PDSCH in DCI format 1_0 or 1_1.

In LTE V2X, separate HARQ ACK/NACK information is not transmitted to reduce system overhead, and for data transmission reliability, a transmitting user equipment may retransmit data once according to selection. However, NR V2X may transmit HARQ ACK/NACK information in terms of data transmission reliability, and in this case, overhead may be reduced by bundling and transmitting the corresponding information.

That is, when a transmitting user equipment (UE1) transmits three pieces of data to a receiving user equipment (UE2), and the receiving user equipment generates HARQ ACK/NACK information for the data, this may be bundled and transmitted through a PSCCH. Although the drawings illustrate HARQ ACK/NACK being transmitted through a PSCCH, it may also be transmitted through a separate channel or another channel, and the bundled HARQ information may comprise 3 bits or less.

Meanwhile, for FR1 corresponding to a frequency range below 3 GHZ, 15 kHz, 30 kHz, 60 kHz, and 120 kHz are discussed as candidates for Subcarrier Spacing (SCS). Further, for FR2 corresponding to a frequency range above 3 GHZ, 30 kHz, 60 kHz, 120 kHz, and 240 kHz are discussed as candidates for SCS. NR V2X may support mini-slots (e.g., 2/4/7 symbols) smaller than 14 symbols as a minimum scheduling unit.

NR V2X sidelink communication may define at least two sidelink resource allocation modes, namely Mode 3 and Mode 4. In Mode 3, a base station schedules sidelink resource(s) used by a user equipment for sidelink transmission. In Mode 4, a user equipment determines sidelink transmission resource(s) within sidelink resources configured by a base station or pre-configured sidelink resources.

Mode 4 may cover the following resource allocation sub-modes: That is, a UE may automatically select sidelink resources for transmission, assist in sidelink resource selection for other UE(s), be configured with a configured grant for sidelink transmission, or schedule sidelink transmission of other user equipment(s).

A V2X user equipment may perform message (or channel) transmission on a pre-defined (or signaled) resource pool. Here, the resource pool may mean pre-defined resource(s) for a user equipment to perform V2X operation (or capable of performing V2X operation). At this time, the resource pool may be defined, for example, in terms of time-frequency. Meanwhile, various types of V2X transmission resource pools may exist.

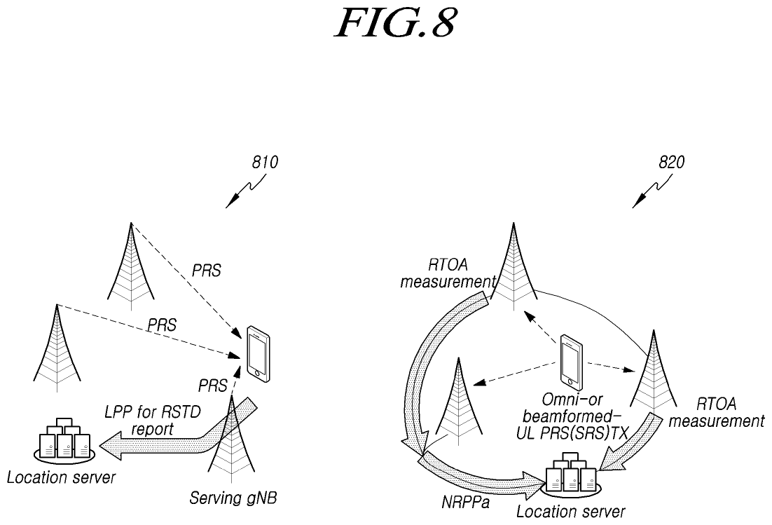

FIG. 8 is a diagram for explaining a base station-based user equipment position estimation operation.

Referring to FIG. 8, a position of a user equipment may be estimated through DL-OTDOA (Downlink-observed time difference of arrival) and UL-TDOA (Uplink-time difference of arrival). In OTDOA, as shown in 810, a UE receives a Positioning Reference Signal (PRS) transmitted from a plurality of base stations and measures a Reference Signal Time Difference (RSTD). This measured information is transmitted to a location server through a serving base station, and the server identifies a position of the user equipment (UE) based on a position of the base station and the RSTD measurement value. LPP is an abbreviation for LTE positioning protocol, which means a protocol for position measurement in LTE.

On the other hand, UL-TDOA means Uplink-time difference of arrival, and is referred to as UTDOA in LTE. In this method, as shown in 820, a base station receives a Sounding Reference Signal (SRS) of a UE and measures a Relative Time of Arrival (RTOA). This measured information is also transmitted to a location server, and a position of the UE is determined using the position of the base station and the RTOA measurement value. In particular, the UL-TDOA method is effective because the complexity of UE position determination is low. These technologies continue to be utilized in 5G standards, and play an important role in increasing the accuracy and efficiency of position determination. NRPP is an abbreviation for NR positioning protocol, which means a protocol for position measurement in NR.

The present disclosure relates to a technology in which a user equipment reports a position of the user equipment to a core network entity in a sidelink communication environment. A position measurement scheme applied to the present disclosure may apply the position measurement methods according to the downlink and uplink described above. In addition, various known position measurement technologies may be applied. Hereinafter, an operation in which a user equipment measures a position using an SL-PRS through a signal flow among the user equipment, a base station, and a core network entity in a sidelink environment will be exemplarily described.

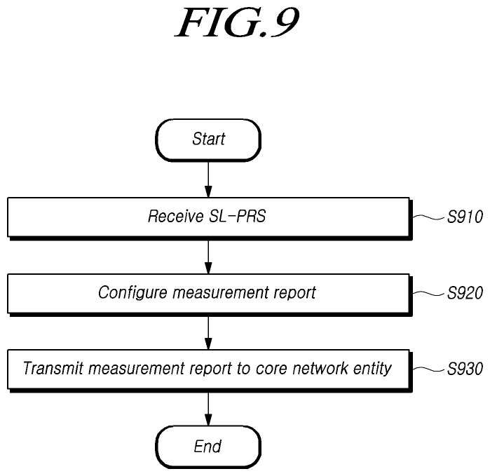

FIG. 9 is a diagram for explaining a user equipment operation according to an embodiment.

Referring to FIG. 9, in a method of reporting location information using sidelink communication, a user equipment (UE) may perform a step of receiving a Sidelink-Positioning Reference Signal (SL-PRS) from a plurality of other user equipments through the sidelink communication (S910).

For example, the user equipment may receive the SL-PRS from one or more other user equipments performing the sidelink communication using a sidelink communication protocol. The SL-PRS may be transmitted by a request of the user equipment. Alternatively, the SL-PRS may be periodically transmitted and received by the user equipment.

When transmitting two or more SL-PRSs, the plurality of other user equipments may further transmit at least one of SL-PRS identification information and SL-PRS transmission time information. For example, the other user equipment transmitting the SL-PRS may transmit the SL-PRS in two or more SL-PRS resources. In this case, the other user equipment may transmit identification information for distinguishing the SL-PRS. Alternatively, the other user equipment may transmit transmission time information at which the SL-PRS was transmitted. The SL-PRS transmission time information is information on a time when the SL-PRS is transmitted, and may be delivered as time stamp information. For example, the SL-PRS transmission time information may be time stamp information at which the other user equipment transmitted the SL-PRS. In addition, the SL-PRS identification information may be SL-PRS resource ID information indicating a transmission resource used for transmission of the SL-PRS.

The user equipment may perform a step of configuring a measurement report based on reception information of the SL-PRS (S920).

For example, the user equipment may receive the SL-PRS and configure the measurement report. A reporting configuration of the measurement report may be set by higher layer signaling and/or lower layer signaling. For example, the user equipment may receive measurement report transmission period information, information parameters included in the measurement report, and the like through an RRC message and configure them in the user equipment.

Meanwhile, the measurement report may comprise transmission and reception time difference information of the SL-PRS, SL-PRS identification information for identifying the SL-PRS, and SL-PRS transmission time information at which the SL-PRS was transmitted. For example, the measurement report may comprise transmission and reception time difference information of a plurality of the SL-PRSs for N different receptions for the same SL-PRS transmitted by the other user equipment or for the same one reception for N different SL-PRS transmissions transmitted by the other user equipment. Here, N may be a value set by higher layer signaling or DCI. As an example, N may be set to any one value among 2, 3, and 4.

For example, when the other user equipment transmits the SL-PRS, the user equipment may receive the SL-PRS through a plurality of different panels configured in the user equipment. In this case, the user equipment may generate N pieces of transmission and reception time difference information based on a difference from transmission for each reception of the SL-PRS and include them in the measurement report. Similarly, when the other user equipment transmits the SL-PRS through different panels or when a plurality of different other user equipments transmit the SL-PRS, the user equipment may receive them with a single panel and generate and report N pieces of transmission and reception time difference information.

The SL-PRS identification information included in the measurement report may be SL-PRS resource ID information indicating a transmission resource used for transmission of the SL-PRS. In addition, the SL-PRS transmission time information included in the measurement report may be time stamp information at which the other user equipment transmitted the SL-PRS.

The user equipment may perform a step of transmitting the measurement report to a core network entity (S930).

For example, the user equipment transmits the measurement report to the core network entity through a base station. The core network entity may receive the measurement report and estimate a location of the user equipment. For example, the core network entity may be a location management function (LMF) entity. In this case, the user equipment may transmit the measurement report to the core network entity through NAS signaling. Alternatively, the user equipment may deliver the measurement report to the core network entity by transmitting the measurement report included in an uplink message to the base station.

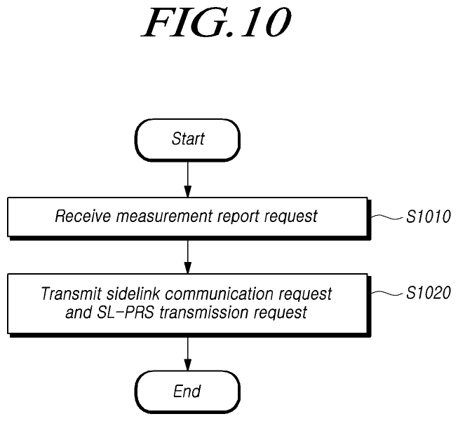

FIG. 10 is a diagram for explaining an operation of a user equipment according to another embodiment.

Referring to FIG. 10, an operation in which the user equipment transmits and receives the SL-PRS through the sidelink communication will be further described. The operation in FIG. 10 may be performed before step S910.

Before the step of receiving the SL-PRS, the user equipment may perform a step of receiving a measurement report transmission request from the core network entity (S1010).

For example, the user equipment may receive a higher layer message requesting transmission of the measurement report from the core network entity. Here, the higher layer message may be a NAS message. Alternatively, the user equipment may receive a message requesting transmission of the measurement report from the core network entity through the base station.

As described above, the measurement report may be transmitted periodically or by a request of the core network entity. Accordingly, when the measurement report transmission request is received, the user equipment may generate the measurement report and report it to the core network entity.

In addition, the user equipment may perform a step of transmitting a sidelink communication request and an SL-PRS transmission request to the plurality of other user equipments (S1020).

For example, when a measurement report request is received, the user equipment may request SL-PRS transmission to other user equipment for measurement report transmission. If necessary, the user equipment may first transmit a sidelink communication request to other user equipment targeted for SL-PRS transmission, and when other user equipment capable of sidelink communication is confirmed, the user equipment may request SL-PRS transmission to the corresponding other user equipment.

For example, the user equipment may request sidelink communication via groupcast or unicast communication. In this case, a communication request may be included in sidelink control information and transmitted to other user equipment. If other user equipment capable of sidelink communication (e.g., user equipment that transmitted HARQ ACK) exists, the user equipment may request SL-PRS transmission to the corresponding other user equipment. The SL-PRS transmission request may be included in PSSCH or PSCCH and transmitted.

Thereafter, the user equipment may transmit a measurement report to the core network entity through the operation described with reference to FIG. 9.

Alternatively, the user equipment may transmit a measurement report to the core network entity periodically or when a preset event is satisfied, even if there is no request from the core network entity.

Hereinafter, various embodiments of the present disclosure performed by at least one of the user equipment, the base station, and the core network entity described above will be described. The following embodiments may operate individually or in any combination.

In sidelink communication, a positioning reference signal (position reference signal, SL-PRS) may be configured to be transmitted periodically or upon request. A position may be estimated through an OTDOA or TDOA scheme using the sidelink positioning reference signal. In particular, a time information transmission/reception technology according to an environment such as groupcast or unicast in SL-PRS communication is proposed. Hereinafter, the core network entity will be described by way of example as an LMF.

A location information transmission procedure of the user equipment may be divided into two modes. First, in a UE-assisted mode, the LMF transmits a location information request to the UE. In response thereto, the UE must transmit location information (i.e., UE measurement values) to the LMF within a designated response time. Second, in a UE-based or standalone mode, the UE directly transmits a location information message comprising UE information and estimated position values even when there is no LMF request.

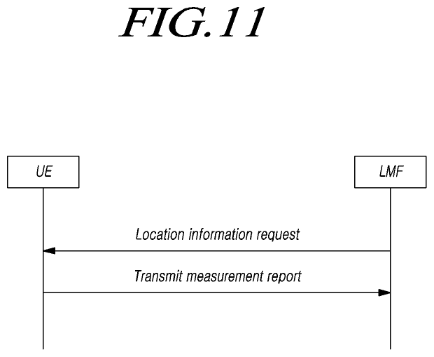

FIG. 11 is a diagram for explaining a signal flow between a core network entity and user equipment according to an embodiment.

Referring to FIG. 11, the LMF may request transmission of location information to the user equipment. When the user equipment receives the request for transmission of location information from the LMF, the user equipment may transmit a measurement report to the LMF. As described above, the measurement report may comprise transmission and reception time difference information of the SL-PRS, transmission time stamp information, SL-PRS resource ID information for identifying the SL-PRS, and the like.

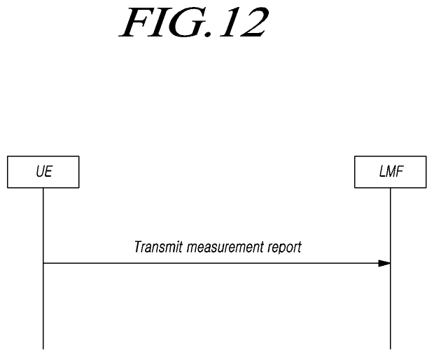

FIG. 12 is a diagram for explaining a signal flow from user equipment to a core network entity according to another embodiment.

Referring to FIG. 12, the user equipment may transmit a measurement report even when there is no separate request from the LMF in a standalone mode. For example, the measurement report may comprise transmission and reception time difference information of the SL-PRS, transmission time stamp information, SL-PRS resource ID information for identifying the SL-PRS, and the like. The measurement report may be transmitted periodically, and the period may be pre-configured in the user equipment through an upper layer message. Alternatively, the measurement report may be transmitted without an LMF request when a preset event condition is satisfied.

Meanwhile, for the definition of SL-PRS-based Rx-Tx measurement, the actual SL-PRS transmission time may be used for the definition of SL-PRS-based Rx-Tx time difference measurement when the UE optionally reports Tx time information. Otherwise, it may be defined for a UE Rx-Tx time difference of gNB Rx-Tx time difference/Uu. For example, the Rx-Tx measurement value may be set within [−0.5 0.5] ms.

The UE must transmit SL Rx-Tx time difference measurement and transmission time information to the LMF.

When the UE transmits one or more SL PRSs, an SL PRS ID may be included in the SL Rx-Tx time difference measurement value.

The transmitted SL-PRS time stamp may be included as Tx time information and reported when reporting the Rx-Tx time difference measurement value.

For example, if synchronization timing of other user equipment changes between Rx and Tx of the SL-PRS for SL Rx-Rx time difference measurement, other user equipment transmitting the SL-PRS may need to transmit SL-PRS transmission time information to user equipment receiving the SL-PRS.

When the user equipment receives the SL-PRS transmission time information from the other user equipment, the user equipment may use actual SL-PRS reception time information and the SL-PRS transmission time information for Rx-Tx time difference measurement.

Meanwhile, in a sidelink environment, the user equipment may operate in various communication environments. For example, the user equipment may perform communication through any one mode among a broadcast mode, a groupcast mode, and a unicast mode. Mode change between the respective modes is also possible.

As an example, in a sidelink-based groupcast communication environment, the other user equipment within a group may transmit Tx time information.

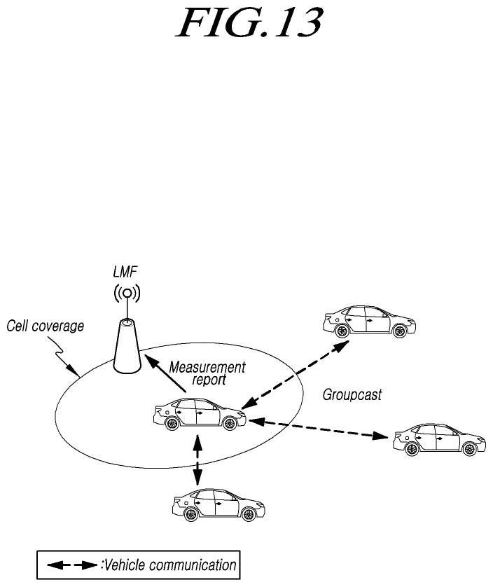

FIG. 13 is a view for explaining a groupcast-based location reporting operation according to an embodiment.

Referring to FIG. 13, a base station or an LMF may obtain Tx time information from the user equipment or an anchor user equipment. In this case, the user equipment or the anchor user equipment may receive Tx time information of other user equipments within a groupcast communication range and deliver the same to the base station.

For example, an operation may be performed according to the following procedure.

2-1. A case where a user equipment UE1 connected to a gNB (or an LMF) acquires Tx information from user equipments (UEs) not connected to the gNB within a group

\textcircled{1}. UE1 requests communication from UEs within the group.

\textcircled{2}. The UEs within the group transmit an HARQ response to UE1.

\textcircled{3}. UE1 requests a PRS from the UEs when there is no failure in the HARQ

response received from the UEs.

\textcircled{4}. The UEs transmit the PRS to UE1. Here, the PRS is an SL-PRS.

\textcircled{5}. The UEs transmit Tx time information and a PRS-ID of the transmitted SL-PRS to UE1.

\textcircled{6}. UE1 reports the Tx time information and measured Rx-Tx time information to the LMF.

2-2. A failure situation in which UE1 does not communicate with UEs within the group

\textcircled{1}. UE1 requests communication from UEs within the group

\textcircled{2}. UEs that failed to communicate with UE1 within the group transmit a NACK to UE1, and UEs that succeeded in communication transmit an ACK to UE1. Alternatively, in groupcast, UE1 may assume that UEs from which a NACK is not received are ACKs. That is, a NACK-only HARQ process may be applied in groupcast.

\textcircled{3}. UE1 requests an SL-PRS from the UEs from which an ACK was received (from which a NACK was not received).

\textcircled{4}. The UEs that transmitted the ACK (did not transmit the NACK) transmit the SL-PRS to UE1.

\textcircled{5}. The UEs transmit Tx time information and a PRS-ID of the transmitted SL-PRS to UE1.

\textcircled{6}. UE1 reports the Tx time information and the measured Rx-Tx time information to the LMF.

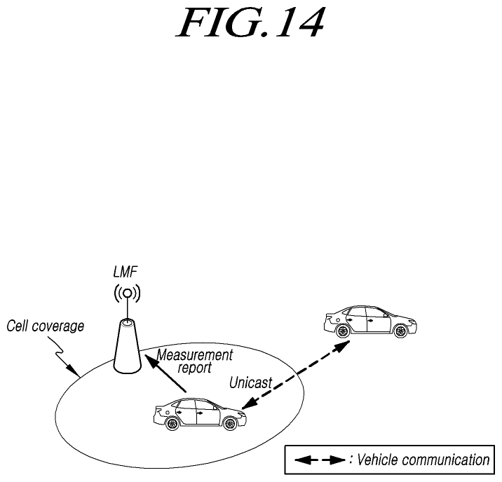

FIG. 14 is a diagram for explaining a unicast-based location reporting operation according to another embodiment.

Referring to FIG. 14, a user equipment connected to a base station (or an LMF) may deliver Tx time information acquired from a user equipment not connected to the base station (or the LMF) to the base station (or the LMF).

3-1. Case where UE1, which is a user equipment connected to a gNB, acquires Tx information from UE2, which is a user equipment not connected to the gNB

\textcircled{1}. UE1 requests communication from UE2.

\textcircled{2}. UE2 transmits an HARQ response to UE1.

\textcircled{3}. UE1 requests an SL-PRS from UE2 when there is no failure in the HARQ response received from UE2.

\textcircled{4}. UE2 transmits the SL-PRS to UE1.

\textcircled{5}. UE2 transmits Tx time information and an SL-PRS-ID (SL-PRS resource identification information) of the transmitted SL-PRS to UE1.

\textcircled{6}. UE1 reports the Tx time information and the measured Rx-Tx time information to the LMF.

3-2. A failure situation in which UE1 does not communicate with a counterpart user equipment UE2

\textcircled{1}. The UE requests communication from UE2.

\textcircled{2}. If UE2 fails to communicate with UE1, UE2 transmits a NACK to UE1.

Meanwhile, as described above, the LMF may request Tx time information from the user equipment. The Tx time information request may be included in a measurement report transmission request. Alternatively, the Tx time information request may be performed separately from the measurement report transmission request.

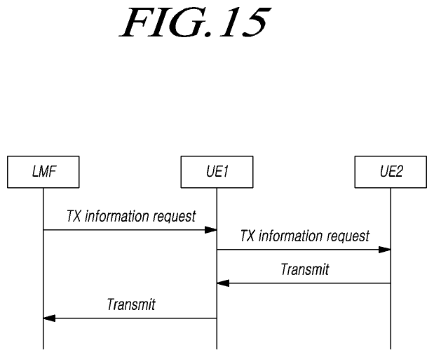

FIG. 15 is a flowchart for explaining an operation of delivering transmission time information according to an embodiment.

Referring to FIG. 15, the LMF may request Tx time information from the user equipment, and in response thereto, the user equipment may report the Tx time information to the LMF. In this case, the user equipment (UE1) that received the request may deliver the request to another user equipment (UE2), receive a response, and report the response to the LMF.

For example, operations may be performed according to the following procedure.

\textcircled{1}. The gNB requests communication from UE1.

\textcircled{2}. UE1 transmits an HARQ response to the gNB.

\textcircled{3}. The LMF requests Tx time information from UE1 connected to the gNB.

\textcircled{4}. UE1 acquires Tx information as shown in FIGS. 13 and 14 in unicast and groupcast situations, respectively.

\textcircled{5}. UE1 reports the Tx time information and Rx-Tx time information to the LMF.

According to the above operations, the Tx time information may be delivered to the core network entity in consideration of various sidelink communication schemes.

Hereinafter, a configuration of a user equipment implementing the above-described operations will be briefly described. The user equipment described below may perform at least part of the operations for implementing the above-described operations.

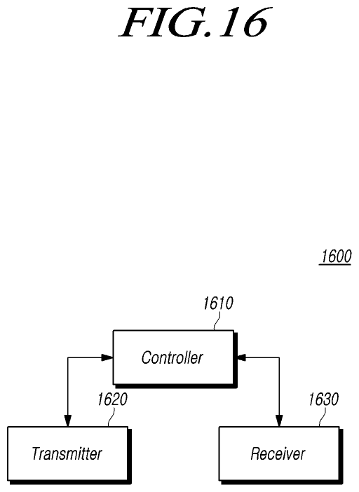

FIG. 16 is a diagram illustrating a configuration of a user equipment according to an embodiment.

Referring to FIG. 16, a user equipment 1600 reporting location information using sidelink communication may comprise a receiver 1630 configured to receive a Sidelink-Positioning Reference Signal (SL-PRS) from a plurality of other user equipments through the sidelink communication, a controller 1610 configured to configure a measurement report based on reception information of the SL-PRS, and a transmitter 1620 configured to transmit the measurement report to a core network entity.

For example, the receiver 1630 may receive the SL-PRS from one or more other user equipments performing the sidelink communication using a sidelink communication protocol. The SL-PRS may be transmitted by a request of the user equipment. Alternatively, the SL-PRS may be periodically transmitted and received by the receiver 1630.

When transmitting two or more SL-PRSs, the plurality of other user equipments may further transmit at least one of SL-PRS identification information and SL-PRS transmission time information. For example, the other user equipment transmitting the SL-PRS may transmit the SL-PRS in two or more SL-PRS resources. In this case, the other user equipment may transmit identification information for identifying the SL-PRS. Alternatively, the other user equipment may transmit transmission time information at which the SL-PRS was transmitted. The SL-PRS transmission time information is information on a time at which the SL-PRS is transmitted, and may be delivered as time stamp information. For example, the SL-PRS transmission time information may be time stamp information at which the other user equipment transmitted the SL-PRS. In addition, the SL-PRS identification information may be SL-PRS resource ID information indicating a transmission resource used for transmission of the SL-PRS.

The controller 1610 may receive the SL-PRS and configure the measurement report. A reporting configuration of the measurement report may be set by higher layer signaling and/or lower layer signaling. For example, the controller 1610 may receive measurement report transmission period information, information parameters included in the measurement report, and the like through an RRC message and configure them in the user equipment 1600.

Meanwhile, the measurement report may comprise transmission and reception time difference information of the SL-PRS, SL-PRS identification information for identifying the SL-PRS, and SL-PRS transmission time information at which the SL-PRS is transmitted. For example, the measurement report may comprise transmission and reception time difference information of a plurality of the SL-PRSs for N different receptions for the same SL-PRS transmitted by the other user equipment or for the same one reception for N different SL-PRS transmissions transmitted by the other user equipment. Here, N may be a value set by higher layer signaling or DCI. As an example, N may be set to any one value among 2, 3, and 4.

For example, when the other user equipment transmits the SL-PRS, the user equipment may receive the SL-PRS through a plurality of different panels configured in the user equipment. In this case, the controller 1610 may generate N pieces of transmission and reception time difference information for each reception of the SL-PRS based on a difference from the transmission and comprise the same in the measurement report. Similarly, when the other user equipment transmits the SL-PRS through different panels or a plurality of different other user equipments transmit the SL-PRS, the controller 1610 may generate and report N pieces of transmission and reception time difference information received by a single panel.

The SL-PRS identification information comprised in the measurement report may be SL-PRS resource ID information indicating a transmission resource used for transmission of the SL-PRS. In addition, the SL-PRS transmission time information comprised in the measurement report may be time stamp information at which the other user equipment transmitted the SL-PRS.

For example, the transmitter 1620 transmits the measurement report to the core network entity through a base station. The core network entity may receive the measurement report and estimate a location of the user equipment. For example, the core network entity may be a location management function (LMF) entity. In this case, the user equipment may transmit the measurement report to the core network entity through NAS signaling. Alternatively, the transmitter 1620 may deliver the measurement report to the core network entity by transmitting the measurement report to the base station while comprising the same in an uplink message.

Meanwhile, before the receiving of the SL-PRS, the receiver 1630 may receive a measurement report transmission request from the core network entity.

For example, the receiver 1630 may receive a higher layer message requesting transmission of the measurement report from the core network entity. Here, the higher layer message may be a NAS message. Alternatively, the receiver 1630 may receive a message requesting transmission of the measurement report from the core network entity through the base station.

As described above, the measurement report may be transmitted periodically or by a request of the core network entity. Accordingly, when the measurement report transmission request is received, the user equipment may generate the measurement report and report the same to the core network entity.

In addition, the transmitter 1620 may transmit a sidelink communication request and an SL-PRS transmission request to the plurality of other user equipments. For example, when the measurement report request is received, the transmitter 1620 may request SL-PRS transmission from the other user equipment for transmission of the measurement report. If necessary, the transmitter 1620 may first transmit the sidelink communication request to the other user equipment that is a target for SL-PRS transmission, and when the other user equipment capable of sidelink communication is determined, the transmitter 1620 may request SL-PRS transmission from the corresponding other user equipment.

For example, the transmitter 1620 may request the sidelink communication through groupcast or unicast communication. In this case, a communication request may be comprised in sidelink control information and transmitted to the other user equipment. When there is the other user equipment capable of sidelink communication (e.g., a user equipment that has transmitted a HARQ ACK), the user equipment may request SL-PRS transmission from the corresponding other user equipment. The SL-PRS transmission request may be comprised in a PSSCH or a PSCCH and transmitted.

Thereafter, the user equipment may perform the above-described SL-PRS reception and measurement report transmission operations. Alternatively, the transmitter 1620 may transmit the measurement report to the core network entity periodically or when a preset event is satisfied even when there is no request from the core network entity.

In addition to this, the receiver 1630 receives downlink control information, data, and messages from the base station or the core network entity through a corresponding channel.

The controller 1610 controls overall operations of the user equipment 1600 according to operations necessary to perform the above-described embodiments.

The transmitter 1620 transmits uplink control information, data, and messages to the base station or the core network entity through a corresponding channel.

The above-described embodiments may be supported by standard documents disclosed in at least one of wireless access systems, which are IEEE 802, 3GPP, and 3GPP2. That is, steps, configurations, and parts not described to clearly reveal the technical spirit among the present embodiments may be supported by the above-described standard documents. In addition, all terms disclosed in the present specification may be explained by the standard documents disclosed above.

The above-described embodiments may be implemented through various means. For example, the present embodiments may be implemented by hardware, firmware, software, or a combination thereof.

In the case of implementation by hardware, the method according to the present embodiments may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of implementation by firmware or software, the method according to the present embodiments may be implemented in the form of an apparatus, a procedure, or a function that performs the functions or operations described above. Software code may be stored in a memory unit and driven by a processor. The memory unit may be located inside or outside the processor, and may exchange data with the processor by various known means.

In addition, terms such as “system”, “processor”, “controller”, “component”, “module”, “interface”, “model”, or “unit” described above may generally refer to computer-related entity hardware, a combination of hardware and software, software, or software in execution. For example, the aforementioned components may be, but are not limited to, a process driven by a processor, a processor, a controller, a control processor, an object, an execution thread, a program, and/or a computer. For example, both an application running on a controller or a processor and the controller or the processor may be components. One or more components may be within a process and/or an execution thread, and the components may be located in one device (e.g., a system, a computing device, etc.) or may be distributed across two or more devices.

The above description is merely illustrative of the technical idea of the present disclosure, and those of ordinary skill in the art to which the present disclosure pertains will be able to make various modifications and variations without departing from the essential characteristics of the technical idea. In addition, the present embodiments are not intended to limit the technical idea of the present disclosure but to explain it, and thus the scope of the technical idea is not limited by these embodiments. The scope of protection of the present disclosure should be interpreted by the following claims, and all technical ideas within the equivalent scope should be interpreted as being comprised in the scope of rights of the present disclosure.

1. A method of reporting location information using sidelink communication by a user equipment (UE), the method comprising:
receiving a Sidelink-Positioning Reference Signal (SL-PRS) from a plurality of other user equipment through the sidelink communication;
configuring a measurement report based on reception information of the SL-PRS; and
transmitting the measurement report to a core network entity.

2. The method of claim 1, wherein the plurality of other user equipment further transmit at least one of SL-PRS identification information and SL-PRS transmission time information when transmitting two or more SL-PRS.

3. The method of claim 1, wherein the measurement report comprises transmission and reception time difference information of the SL-PRS, SL-PRS identification information for identifying the SL-PRS, and SL-PRS transmission time information at which the SL-PRS is transmitted.

4. The method of claim 3, wherein the measurement report comprises transmission and reception time difference information of a plurality of the SL-PRS for N different receptions for the same SL-PRS transmitted by the other user equipment or for the same one reception for N different SL-PRS transmissions transmitted by the other user equipment.

5. The method of claim 4, wherein the N is any one of 2, 3, and 4.

6. The method of claim 3, wherein the SL-PRS identification information is SL-PRS resource ID information indicating a transmission resource used for transmission of the SL-PRS.

7. The method of claim 3, wherein the SL-PRS transmission time information is time stamp information at which the other user equipment transmit the SL-PRS.

8. The method of claim 1, wherein the core network entity is a location management function (LMF) entity.

9. The method of claim 1, further comprising, before the receiving of the SL-PRS:
receiving a measurement report transmission request from the core network entity; and
transmitting a sidelink communication request and an SL-PRS transmission request to the plurality of other user equipment.

10. The method of claim 9, wherein the plurality of other user equipment receive the sidelink communication request and the SL-PRS transmission request through groupcast or unicast communication.

11. A user equipment for reporting location information using sidelink communication, the user equipment comprising:
a receiver configured to receive a Sidelink-Positioning Reference Signal (SL-PRS) from a plurality of other user equipment through the sidelink communication;
a controller configured to configure a measurement report based on reception information of the SL-PRS; and
a transmitter configured to transmit the measurement report to a core network entity.

12. The user equipment of claim 11, wherein the plurality of other user equipment further transmit at least one of SL-PRS identification information and SL-PRS transmission time information when transmitting two or more SL-PRS.

13. The user equipment of claim 11, wherein the measurement report comprises transmission and reception time difference information of the SL-PRS, SL-PRS identification information for identifying the SL-PRS, and SL-PRS transmission time information at which the SL-PRS is transmitted.

14. The user equipment of claim 13, wherein the measurement report comprises transmission and reception time difference information of a plurality of the SL-PRS for N different receptions for the same SL-PRS transmitted by the other user equipment or for the same one reception for N different SL-PRS transmissions transmitted by the other user equipment.

15. The user equipment of claim 14, wherein the Nis any one of 2, 3, and 4.

16. The user equipment of claim 13, wherein the SL-PRS identification information is SL-PRS resource ID information indicating a transmission resource used for transmission of the SL-PRS.

17. The user equipment of claim 13, wherein the SL-PRS transmission time information is time stamp information at which the other user equipment transmit the SL-PRS.

18. The user equipment of claim 11, wherein the core network entity is a location management function (LMF) entity.

19. The user equipment of claim 11, wherein the receiver is further configured to receive a measurement report transmission request from the core network entity before the receiving of the SL-PRS, and
the transmitter is further configured to transmit a sidelink communication request and an SL-PRS transmission request to the plurality of other user equipment.

20. The user equipment of claim 19, wherein the plurality of other user equipment receive the sidelink communication request and the SL-PRS transmission request through groupcast or unicast communication.
